(19) United States
(12) Patent Application Publication
(10) Pub. No.: US 2012/0033164 A1
(43) Pub. Date: Feb. 9, 2012

(54) LIQUID CRYSTAL DISPLAY DEVICE AND BLUE COLOR FILTER THEREOF

(76) Inventors: Chung-Ting Chen, Hsin-Chu (TW); Chen-Hsien Liao, Hsin-Chu (TW)

(21) Appl. No.: 13/075,170

(22) Filed: Mar. 29, 2011

(30) Foreign Application Priority Data
Aug. 3, 2010 (TW) 099125804

(51) Int. Cl. G02F 1/1335; C09B 1/52; G02B 5/20

(52) U.S. Cl. 349/108; 552/227

(57) ABSTRACT

A liquid crystal display device includes a white light emitting diode backlight module for supplying white light, a plurality of red sub-pixels, a plurality of green sub-pixels and a plurality of blue sub-pixels. Each of the blue sub-pixels includes a blue color filter, and each of the blue color filters has a blue light wavelength-transmittance relationship curve. A ratio of a maximum transmittance of the blue light wavelength-transmittance relationship curve to a full width at half maximum value of the maximum transmittance is greater than or equal to 0.0075.

### BACKGROUND OF THE INVENTION

1. Field of the Invention

The present invention relates to a liquid crystal display device, and more particularly, to a liquid crystal display device, which utilizes a white light emitting diode (WLED) backlight module employing a blue color filter with high transmittance to achieve high color temperature.

2. Description of the Prior Art

Light emitting diodes (LEDs) are increasingly adopted in backlight modules of next-generation liquid crystal TVs and liquid crystal display devices because of advantages such as lower power consumption and longer lifetime. A white light emitting diode (WLED) backlight module used in liquid crystal display devices is formed by combining red light emitting diodes, green light emitting diodes, and blue light emitting diodes. However, this tri-color LED approach for realizing the WLED requires a greater number of light emitting diode units, increasing cost of manufacturing of the backlight module. The white light emitting diode backlight module can generate white light from a single light emitting diode by mixing fluorescent powders that emit red light and green light into the blue light emitting diode. When the concentration of the fluorescent powders mixed into the blue light emitting diode is increased, the luminous efficacy of the light emitting diode is enhanced.

For conventional white light emitting diodes used in backlight modules of TVs and liquid crystal display devices, a white light emitting diode with high color temperature should be used to meet a color temperature specification, which is approximately 9500 Kelvin (K). However, the luminous efficacy of the white light emitting diode with high color temperature is lower than the luminous efficacy of the white light emitting diode with low color temperature. Therefore, more white light emitting diode units are needed to enhance the overall luminance of the display device, increasing both the cost and complexity of manufacturing the light emitting diode. Due to the current emphasis on color temperature, the white light emitting diodes with higher luminous efficacy are usually not considered for application in the backlight module of the liquid crystal display device. Thus, power savings and lower manufacturing costs can not be pursued when the color temperature specification is taken into consideration.

### SUMMARY OF THE INVENTION

It is one of the objectives of the present invention to provide a liquid crystal display device employing a blue color filter with high transmittance to solve the problems of the prior art, which can not give consideration to both high color temperature and high luminous efficacy.

To achieve the purpose described above, the present invention provides a liquid crystal display device comprising a white light emitting diode backlight module for supplying white light, a plurality of red sub-pixels, a plurality of green sub-pixels, and a plurality of blue sub-pixels. Each of the blue sub-pixels in the present invention comprises a blue color filter, and each of the blue color filters has a blue light wavelength-transmittance relationship curve, wherein a ratio of a maximum transmittance of the blue light wavelength-transmittance relationship curve to a full width at half maximum value of the maximum transmittance is greater than or equal to 0.0075, and the ratio is substantially between 0.0075 and 0.01.

To achieve the purpose described above, the present invention further provides a blue color filter, and the blue color filter has a blue light wavelength-transmittance relationship curve, wherein a ratio of a maximum transmittance of the blue light wavelength-transmittance relationship curve to a full width at half maximum value of the maximum transmittance is greater than or equal to 0.0075, and the preferred value of the ratio is substantially between 0.0075 and 0.01.

According to the liquid crystal display device employing a kind of blue color filter in the present invention, the transmittance of each of the blue sub-pixels is higher than the blue sub-pixel with the conventional blue color filter. And the whole color temperature and luminance of the liquid crystal display device can be effectively enhanced when the blue sub-pixel has higher transmittance. Therefore, by using the blue color filter of the present invention, the white light emitting diode backlight module with high luminous efficacy and low color temperature can be used in the liquid crystal display device in the present invention, and the specification of high color temperature, which is substantially about 9500K, for TV and liquid crystal display device can be satisfied at the same time. The number of the white light emitting diode used in the backlight module can be reduced, because the white light emitting diode with high luminous efficacy is used in the backlight module in the present invention. The purposes of power saving and manufacturing cost down can both be achieved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a liquid crystal display device according to a preferred embodiment of the present invention.

FIG. 2 is a schematic diagram illustrating a comparison of blue light wavelength-transmittance relationship curves between the blue color filter of a control group and the blue color filter of the liquid crystal display device in the preferred embodiment of the present invention.

FIG. 3 is a schematic diagram illustrating a comparison of red light wavelength-transmittance relationship curves between the red color filter of the control group and the red color filter of the liquid crystal display device in the preferred embodiment of the present invention.

FIG. 4 is a schematic diagram illustrating a comparison of green light wavelength-transmittance relationship curves between the green color filter of the control group and the green color filter of the liquid crystal display device in the preferred embodiment of the present invention.

### DETAILED DESCRIPTION

To provide a better understanding of the present invention to skilled users in the technology of the present invention, preferred embodiments will be detailed as follows. The preferred embodiments of the present invention are illustrated in the accompanying drawings with numbered elements to elaborate the contents and effects to be achieved.

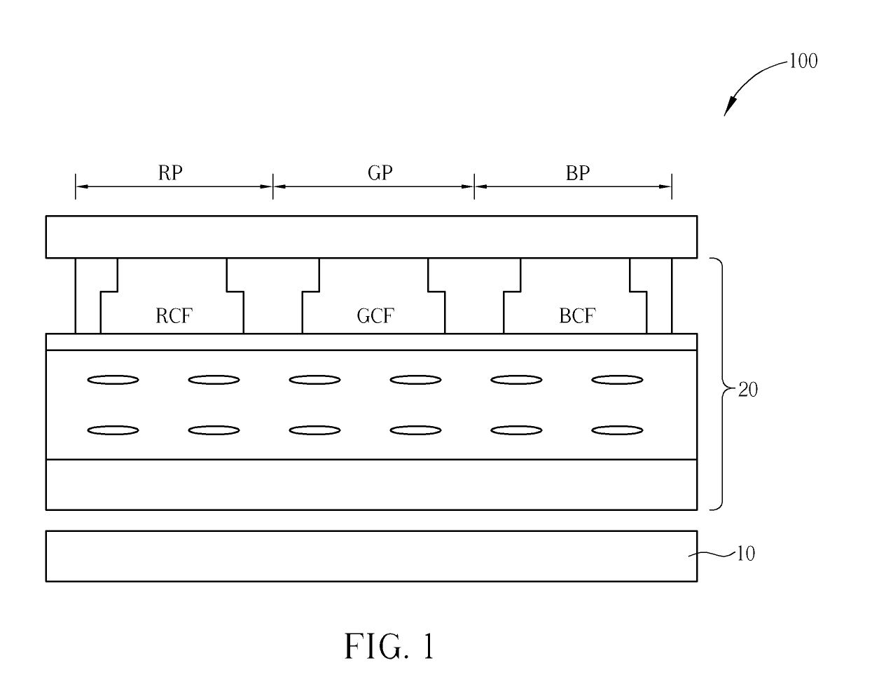

Please refer to FIG. 1. FIG. 1 is a schematic diagram illustrating a liquid crystal display device 100 according to a preferred embodiment of the present invention. As shown in FIG. 1, the liquid crystal display device 100 in the present invention comprises a liquid crystal display panel and a white light emitting diode backlight module 10 for supplying white light. The white light emitting diode backlight module 10 is a backlight module with high luminous efficacy, but the present invention is not limited to this. In addition, the white light emitting diode backlight module 10 in the present invention can emit white light by mixing green and red fluorescent powders into a blue light emitting diode, but the present invention is not limited to this. For example, the white light emitting diode backlight module 10 in the present invention also can emit white light by mixing yellow fluorescent powders into the blue light emitting diode. The liquid crystal display device 100 in the present invention further comprises a plurality of red sub-pixels RP, a plurality of green sub-pixels GP, and a plurality of blue sub-pixels BP. Each of the red sub-pixels RP includes a red color filter RCF disposed corresponding to the red sub-pixel RP, each of the green sub-pixels GP includes a green color filter GCF disposed corresponding to the green sub-pixel GP, and each of the blue sub-pixels BP includes a blue color filter BCF disposed corresponding to the blue sub-pixel BP. To simplify the description and illustration, FIG. 1 only illustrates a red sub-pixel RP, a green sub-pixel GP, and a blue sub-pixel BP. By employing the red color filters RCF, the green color filters GCF, and the blue color filters BCF to the white light emitting diode backlight module 10 of the liquid crystal display device 100 in the present invention, the color temperature is substantially between 6500K and 18000K.

TABLE 1

| | Color Temperature (K) | Luminous Efficacy(lm/W) |
|---|---|---|
| LEDA | 13250 | 66 |
| LEDB | 27399 | 56 |
| LEDC | 35000 | 49 |

To clearly describe relationship between the luminous efficacy and the color temperature of the light emitting diode in the present invention, please refer to Table 1. Table 1 shows the relationship between the luminous efficacy and the color temperature of the white light emitting diode backlight module. As shown in Table 1, the first white light emitting diode LEDA, the second white light emitting diode LEDB, and the third white light emitting diode LEDC are three kinds of white light emitting diodes, which can be used in the backlight module of the liquid crystal display device. The luminous efficacy of the first white light emitting diode LEDA is highest compared to the luminous efficacy of the second white light emitting diode LEDB and the luminous efficacy of the third white light emitting diode LEDC. For instance, the luminous efficacy of the first white light emitting diode LEDA is 66 (lm/W), the luminous efficacy of the second white light emitting diode LEDB is 56 (lm/W), and the luminous efficacy of the third white light emitting diode LEDC is 49 (lm/W). However, in the aspect of color temperature, the color temperature of the first white light emitting diode LEDA with higher luminous efficacy is lower than the color temperatures of the second white light emitting diode LEDB and the third white light emitting diode LEDC with lower luminous efficacy. For instance, the color temperature of the first white light emitting diode LEDA is 13250K, the color temperature of the second white light emitting diode LEDB is 27399K, and the color temperature of the third white light emitting diode LEDC is 35000K. According to the descriptions above, the white light emitting diode with higher luminous efficacy usually has a relatively lower color temperature.

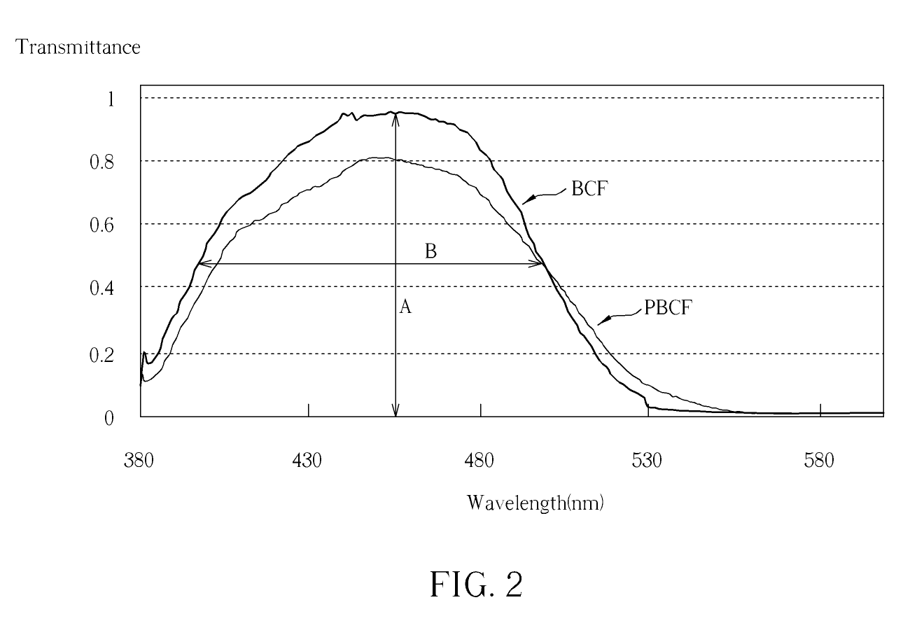

Please refer to FIG. 2. FIG. 2 is a schematic diagram illustrating a comparison of blue light wavelength-transmittance relationship curves of a blue color filter PBCF of a control group and a blue color filter BCF of the liquid crystal display device in the preferred embodiment of the present invention. The X-axis in FIG. 2 represents the wavelength in units of nanometers (nm). The Y-axis represents the transmittance of the blue color filter BCF in the present invention. As shown in FIG. 2, the transmittance of the blue color filter BCF in the present invention is better than the transmittance of the blue color filter PBCF of the control group. In addition, the blue color filter BCF in the present invention has a blue light wavelength-transmittance relationship curve where a ratio (value of A/B) of a maximum transmittance A of the blue light wavelength-transmittance relationship curve to a full width at half maximum value of the maximum transmittance B is greater than or equal to 0.0075, and the preferred value of the ratio is substantially between 0.0075 and 0.01, but the present invention is not limited to this. The maximum transmittance A is the transmittance (transmittance is a relative value without units) corresponding to the highest peak of the blue light wavelength-transmittance relationship curve, and the full width at half maximum value of the maximum transmittance B is the wavelength range corresponding to the value of half of the highest peak of the blue light wavelength-transmittance relationship curve.

Additionally, please refer to formula (I) listed below. Formula (I) illustrates the chemical compound of the material used in the blue color filter of the liquid crystal display device in the preferred embodiment of the present invention. With the chemical compound shown in Formula (I), the blue color filter BCF in the present invention has a better transmittance compared to the blue color filter PBCF of the control group, and the chemical compound of the material used in the blue color filter BCF of the preferred embodiment in the present invention is not limited to this. In addition, the blue color filter BCF in the present invention is made of dyes, photoresists, or multiple layers of films, but the present invention is not limited to this. The output amount of the blue light is increased by enhancing the transmittance of the blue color filter BCF in the embodiment of the present invention. Because blue light has higher color temperature compared to red light and green light, the overall color temperature of the white light emitting diode backlight module in the present invention can be effectively enhanced.

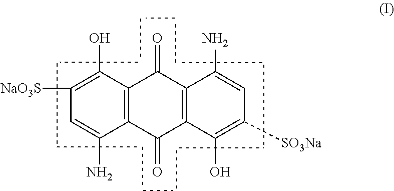

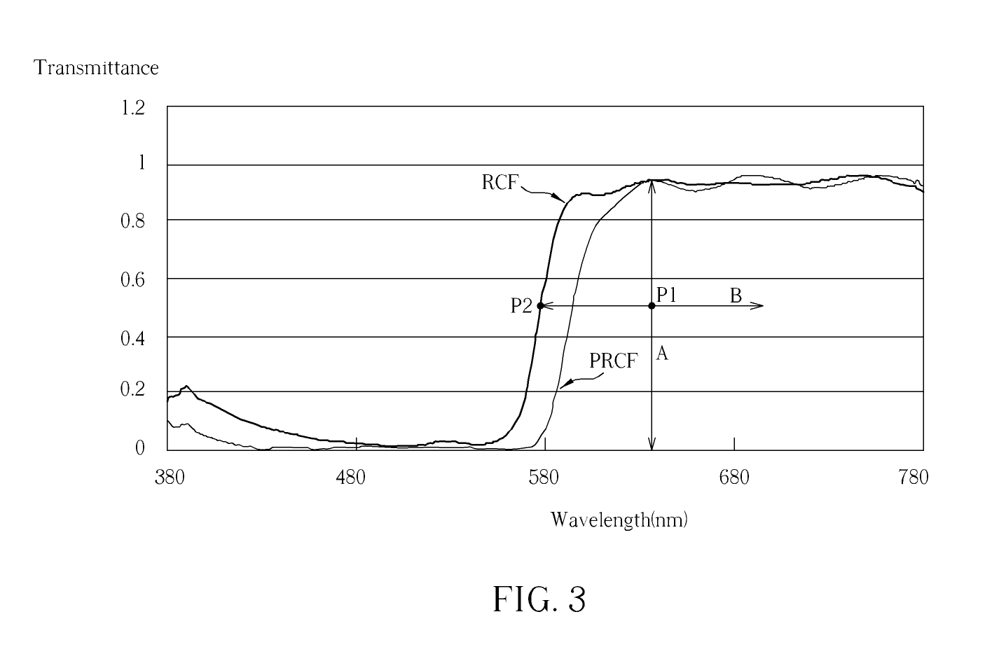

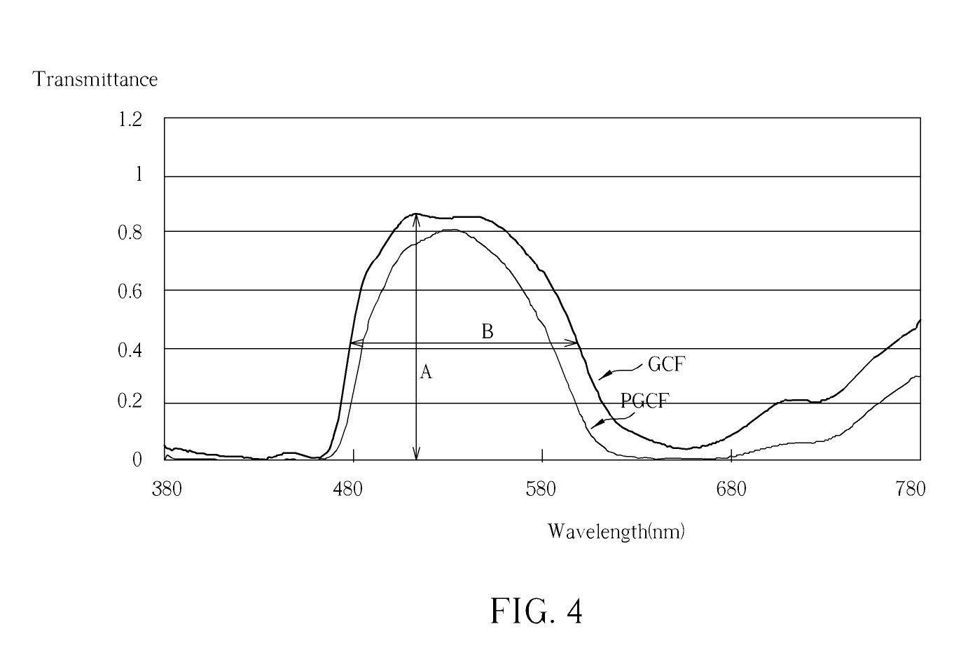

Please refer to FIG. 3 and FIG. 4. FIG. 3 is a schematic diagram illustrating a comparison of red light wavelength-transmittance relationship curves of a red color filter PRCF of the control group and a red color filter RCF of the liquid crystal display device in the preferred embodiment of the present invention. FIG. 4 is a schematic diagram illustrating a comparison of green light wavelength-transmittance relationship curves of a green color filter PGCF of the control group and a green color filter GCF of the liquid crystal display device in the preferred embodiment of the present invention. As shown in FIG. 3, the transmittance of the red color filter RCF in the present invention is better than the transmittance of the red color filter PRCF of the control group. The red color filter RCF in the present invention has a red light wavelength-transmittance relationship curve, and there is a maximum transmittance A in the red light wavelength-transmittance relationship curve. A ratio of the maximum transmittance A to a full width at half maximum value of the maximum transmittance B is greater than or equal to 0.0031, and the preferred value of the ratio is substantially between 0.0031 and 0.0048, but the present invention is not limited to this. Additionally, it is worth mentioning that the red light wavelength-transmittance relationship curve of the red color filter RCF in the present embodiment is not a complete wave pattern. Therefore, when measuring the full width at half maximum value of the maximum transmittance B corresponding to the maximum transmittance A, a half value of the maximum transmittance A of the red light wavelength-transmittance relationship curve is set as a first base point P1, and a point in the red light wavelength-transmittance relationship curve horizontally corresponding to the first base point P1 is set as a second base point P2. Distance between the first base point P1 and the second base point P2 is half of the full width at half maximum value of the maximum transmittance B. The full width at half maximum value of the maximum transmittance B can be obtained by doubling the wavelength range between the first base point P1 and the second base point P2. In addition, as shown in FIG. 4, the transmittance of the green color filter GCF in the present invention is better than the transmittance of the green color filter PGCF of the control group. The green color filter GCF in the present invention has a green light wavelength-transmittance relationship curve, and there is a maximum transmittance A in the green light wavelength-transmittance relationship curve. A ratio of the maximum transmittance A to a full width at half maximum value of the maximum transmittance B is greater than or equal to 0.0074, and the preferred value of the ratio is substantially between 0.0074 and 0.0082, but the present invention is not limited to this.

TABLE 2

| | | | | | | | | | Color |
|---|---|---|---|---|---|---|---|---|---|
| | | | | | | | | | Tem- |
| | | | | | | | | | per- |
| | RCF | | GCF | | BCF | | W | | ature |
| | x | y | x | y | x | y | wx | wy | (K) |
| LEDA | 0.662 | 0.329 | 0.280 | 0.646 | 0.148 | 0.056 | 0.281 | 0.297 | 9450 |

Please refer to Table 2. Table 2 shows the color temperature of the liquid crystal display device in the preferred embodiment of the present invention. The x and y values of the blue color filter BCF, the red color filter RCF, and the green color filter GCF respectively represent blue color coordinates, red color coordinates, and green color coordinates on a chromaticity diagram. Additionally, Table 2 also shows white color coordinates W achieved on the chromaticity diagram by the liquid crystal display device in the present invention, where the white color coordinates W are represented by wx and wy. As shown in Table 2, by employing the above mentioned blue color filter BCF, the above mentioned red color filter RCF, and the above mentioned green color filter GCF, the color temperature of the white light emitting diode backlight module LEDA of the liquid crystal display device in the preferred embodiment of the present invention can effectively reach 9450K, which satisfies the specification for next-generation TVs and liquid crystal display devices. The blue light output is increased by enhancing the transmittance of the blue color filter BCF in this embodiment. Because blue light has higher color temperature compared to red light and green light, the overall color temperature of the white light emitting diode backlight module LEDA in the present invention can be effectively enhanced. Additionally, under the condition that the transmittances of the red color filter and the green color filter are also increased, the luminous efficacy of the white light emitting diode backlight module of the liquid crystal display device in this embodiment can be further enhanced. The purposes of power saving and satisfying the specification can both be achieved.

To summarize the above description, the transmittance of each of the red sub-pixels, the green sub-pixels, and the blue sub-pixels in the liquid crystal display device can be enhanced by employing the above-mentioned red color filter, the above-mentioned green color filter, and the above-mentioned blue color filter in the liquid crystal display device of the present invention. Under the condition that the blue sub-pixel performs with high transmittance, the overall color temperature and the overall luminance displayed by the liquid crystal display device can be effectively enhanced. Therefore, by employing the blue color filter of the present invention, the white light emitting diode backlight module with high luminous efficacy and low color temperature can be used in the liquid crystal display device in the present invention, and the specification of high color temperature for next-generation TVs and liquid crystal display devices can be satisfied at the same time. The number of white light emitting diodes used in the backlight module can be effectively reduced, because the white light emitting diode with high luminous efficacy is used in the backlight module in the present invention. The purposes of power saving and manufacturing cost reduction can both be achieved.

Those skilled in the art will readily observe that numerous modifications and alterations of the device and method may be made while retaining the teachings of the invention.

What is claimed is:

1. A liquid crystal display device, comprising:
a white light emitting diode backlight module for supplying white light; and
a plurality of red sub-pixels, a plurality of green sub-pixels, and a plurality of blue sub-pixels;
wherein each of the blue sub-pixels comprises a blue color filter, and each of the blue color filters has a blue light wavelength-transmittance relationship curve, and wherein a ratio of a maximum transmittance of the blue light wavelength-transmittance relationship curve to a full width at half maximum value of the maximum transmittance is greater than or equal to 0.0075.

2. The liquid crystal display device of claim 1, wherein each of the red sub-pixels comprises a red color filter.

3. The liquid crystal display device of claim 2, wherein the red color filter has a red light transmittance, and each of the red color filters has a red light wavelength-transmittance relationship curve, and wherein a ratio of a maximum transmittance of the red light wavelength-transmittance relationship curve to a full width at half maximum value of the maximum transmittance is greater than or equal to 0.0031.

4. The liquid crystal display device of claim 1, wherein each of the green sub-pixels comprises a green color filter.

5. The liquid crystal display device of claim 4, wherein the green color filter has a green light transmittance, and each of the green color filters has a green light wavelength-transmittance relationship curve, and wherein a ratio of a maximum transmittance of the green light wavelength-transmittance relationship curve to a full width at half maximum value of the maximum transmittance is greater than or equal to 0.0074.

6. The liquid crystal display device of claim 1, wherein each of the blue color filters comprises a chemical compound of formula (I):

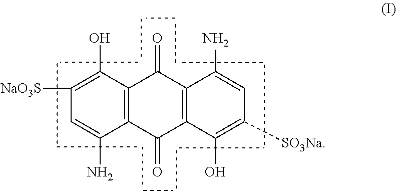

7. The liquid crystal display device of claim 1, wherein a color temperature of the liquid crystal display device is substantially between 6500K and 18000K.

8. A blue color filter, the blue color filter having a blue light wavelength-transmittance relationship curve, wherein a ratio of a maximum transmittance of the blue light wavelength-transmittance relationship curve to a full width at half maximum value of the maximum transmittance is greater than or equal to 0.0075.

9. The blue color filter of claim 8, wherein each of the blue color filters comprises a chemical compound of formula (I): [chemical structure]
